(19) United States
(12) Patent Application Publication
(10) Pub. No.: US 2008/0034183 A1
(43) Pub. Date: Feb. 7, 2008

(54) Protecting Critical Pointer Value Updates To Non-Volatile Memory Under Marginal Write Conditions

(75) Inventors: Randall DRAGO, Gaithersburg, MD (US); Omid ROSHAN-AFSHAR, Herndon, VA (US); Theodore HOCKEY, Mount Airy, MD (US); Joseph WHITE, Woodbine, MD (US); Frederick SCHUESSLER, Baiting Hollow, NY (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/835,201

(22) Filed: Aug. 7, 2007

Related U.S. Application Data
(60) Provisional application No. 60/835,866, filed on Aug. 7, 2006.

(51) Int. Cl. G06F 12/10; G08B 1/08

(52) U.S. Cl. 711/219; 340/572.4

(57) ABSTRACT

Methods, systems, and apparatuses for updating pointers in memory are described. A device can include pointer logic and a memory that stores a memory pointer. The pointer logic can increment or decrement the memory pointer according to Gray code. The device can increment or decrement the memory pointer in response to a pointer change command and can be configured to first verify a password associated with the command. The device can send an acknowledgement that the command has been received and/or executed. Multiple increments or decrements of the memory pointer can occur in response to a pointer change command configured as a single multiple-increment-or-decrement command or as multiple single-increment-or-decrement change commands. The device can determine an updated value for each of a first memory pointer portion and a second memory pointer portion of the memory pointer.

### CROSS-REFERENCE TO RELATED APPLICATIONS

This application claims benefit of U.S. Provisional Patent Appl. No. 60/835,866, filed on Aug. 7, 2006, which is incorporated by reference herein in its entirety.

### BACKGROUND OF THE INVENTION

1. Field of the Invention

The present invention relates to systems or devices containing memory, and in particular, to management of data stored in memory.

2. Background Art

Radio frequency identification (RFID) tags are electronic devices that may be affixed to items whose presence is to be detected and/or monitored. The presence of a RFID tag, and therefore the presence of the item to which the tag is affixed, may be checked and monitored wirelessly by devices known as “readers.” Readers typically have one or more antennas transmitting radio frequency signals to which tags respond. Since the reader “interrogates” RFID tags, and receives signals back from the tags in response to the interrogation, the reader is sometimes termed as “reader interrogator” or simply “interrogator”.

In a RFID system, typically a reader transmits a continuous wave (CW) or modulated radio frequency (RF) signal to a tag. The tag receives the signal, and responds by modulating the signal, “backscattering” an information signal to the reader. The reader receives signals back from the tag, and the signals are demodulated, decoded and further processed.

With the maturation of RFID technology, efficient communications between tags and readers has become a key enabler in supply chain management, especially in manufacturing, shipping, and retail industries, as well as in building security installations, healthcare facilities, libraries, airports, warehouses, etc.

Memory pointer values are often used in systems (not limited to RFID systems) to indicate boundaries or start locations of contents within a memory instance. These pointer values are typically indicated with count values that are modified using normal mathematical constructs, such as addition and subtraction. In cases where writing (or updating) a new pointer value is susceptible to faulty write conditions (e.g., low power or other questionable write procedures that may terminate before verification of a successful write is completed), it may be possible for the updated pointer value to become corrupt. For example, the pointer may be corrupted because multiple bits of the pointer value may need to be changed in the value update, and due to an interruption, all of the bits of the pointer value may not be updated properly.

Such a condition of a corrupted pointer value can be catastrophic for some systems, such as a RFID tag, where a pointer value may be used to protect read or write locked memory boundaries in memory of the tag, for example. Corrupting this type of pointer value may uncover or expose the previously protected memory regions. It is desired to protect information embedded in tags from being obtained by unauthorized readers.

Thus, what is needed are improved ways of maintaining security and/or privacy for data stored in memory, and in particular with regard to memory pointers.

### BRIEF SUMMARY OF THE INVENTION

Methods, systems, and apparatuses for maintaining security and/or privacy for data stored in memory are described. Furthermore, methods, systems, and apparatuses for improved handling of memory pointers are described. Although the example embodiments described include RFID systems, the invention is not to be limited to RFID systems. This invention can be applied to any system or device susceptible to power supply brownout, for example.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows an environment where RFID readers communicate with an exemplary population of RFID tags.

FIG. 2 shows a block diagram of receiver and transmitter portions of a RFID reader.

FIG. 3 shows a block diagram of an example radio frequency identification (RFID) tag.

FIG. 4 shows a logical representation of memory in an example Gen 2-type RFID tag.

FIG. 5 shows an example of further detail of a memory bank in a Gen 2-type tag.

FIG. 6 shows a reader, according to an example embodiment of the present invention.

FIGS. 7A-7C show example types of a pointer change command, according to example embodiments of the present invention.

FIG. 8 shows a tag, according to an example embodiment of the present invention.

FIGS. 9A and 9B show example ways of converting between binary and Gray code.

FIG. 10 shows example communications between a reader and a tag, according to an embodiment of the present invention.

FIG. 11 shows an example memory, according to an embodiment of the present invention.

FIG. 12 shows a tag, according to an example embodiment of the present invention.

FIG. 13 is a flowchart depicting a method for changing a memory pointer, according to an example embodiment of the present invention.

FIG. 14 is a flowchart depicting a method for changing a memory pointer, according to an example embodiment of the present invention.

FIG. 15 is a flowchart depicting an example of additional steps that can be included in the method shown in FIG. 14, according to an embodiment of the present invention.

FIGS. 16 and 17 are each a flowchart further describing step 1406 of the method depicted in FIG. 14, according to example embodiments of the present invention.

FIG. 18 is a flowchart further describing step 1404 of the method depicted in FIG. 14, according to an example embodiment of the present invention.

FIGS. 19 and 20 are each a flowchart depicting an example of an additional step that can be included in the method shown in FIG. 14, according to example embodiments of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

Introduction

Methods, systems, and apparatuses for maintaining security and/or privacy for data stored in memory are described. Furthermore, methods, systems, and apparatuses for improved handling of memory pointers are described. Although the example embodiments described include RFID systems, the invention is not to be limited to RFID systems. This invention can be applied to any system or device susceptible to power supply brownout, for example.

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner. Likewise, particular bit values of “0” or “1” (and representative voltage values) are used in illustrative examples provided herein to represent data for purposes of illustration only. Data described herein can be represented by either bit value (and by alternative voltage values), and embodiments described herein can be configured to operate on either bit value (and any representative voltage value), as would be understood by persons skilled in the relevant art(s).

Example RFID System Embodiment

Before describing embodiments of the present invention in detail, it is helpful to describe an example RFID communications environment in which the invention may be implemented. FIG. 1 illustrates an environment 100 where RFID tag readers 104 communicate with an exemplary population 120 of RFID tags 102. As shown in FIG. 1, the population 120 of tags includes seven tags 102a-102g. A population 120 may include any number of tags 102.

Environment 100 includes any number of one or more readers 104. For example, environment 100 includes a first reader 104a and a second reader 104b. Readers 104a and/or 104b may be requested by an external application to address the population of tags 120. Alternatively, reader 104a and/or reader 104b may have internal logic that initiates communication, or may have a trigger mechanism that an operator of a reader 104 uses to initiate communication. Readers 104a and 104b may also communicate with each other in a reader network.

As shown in FIG. 1, reader 104a transmits an interrogation signal 110a having a carrier frequency to the population of tags 120. Reader 104b transmits an interrogation signal 110b having a carrier frequency to the population of tags 120. Readers 104a and 104b typically operate in one or more of the frequency bands allotted for this type of RF communication. For example, frequency bands of 902-928 MHz and 2400-2483.5 MHz have been defined for certain RFID applications by the Federal Communication Commission (FCC).

Various types of tags 102 may be present in tag population 120 that transmit one or more response signals 112 to an interrogating reader 104, including by alternatively reflecting and absorbing portions of signal 110 according to a time-based pattern or frequency. This technique for alternatively absorbing and reflecting signal 110 is referred to herein as backscatter modulation. Readers 104a and 104b receive and obtain data from response signals 112, such as an identification number of the responding tag 102. In the embodiments described herein, a reader may be capable of communicating with tags 102 according to any suitable communication protocol, including Class 0, Class 1, EPC Gen 2, other binary traversal protocols and slotted aloha protocols, any other protocols mentioned elsewhere herein, and future communication protocols.

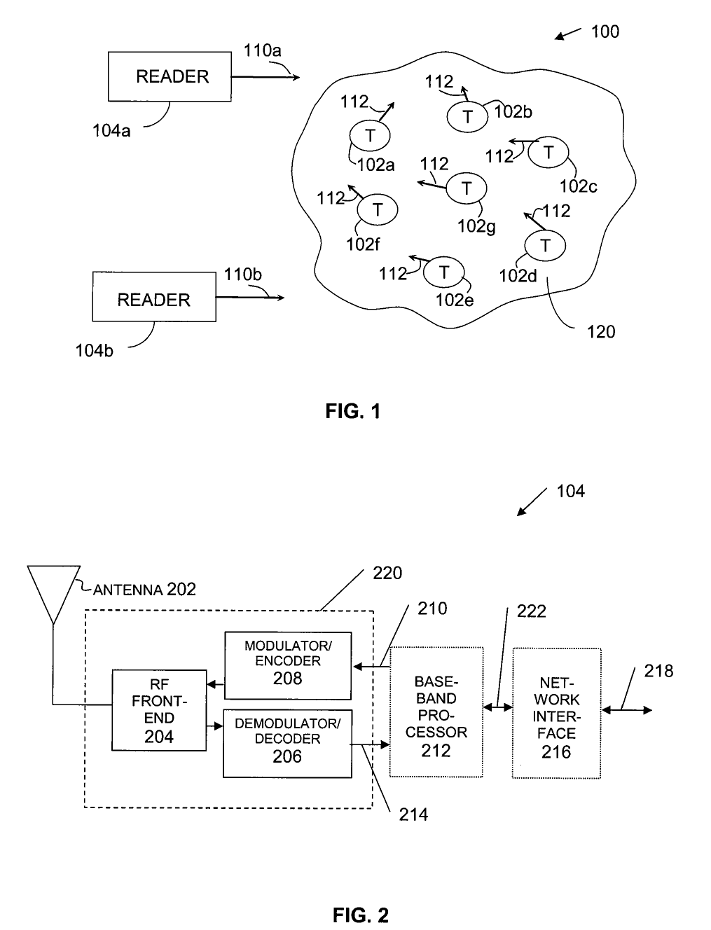

FIG. 2 shows a block diagram of an example RFID reader 104. Reader 104 includes one or more antennas 202, a receiver and transmitter portion 220 (also referred to as transceiver 220), a baseband processor 212, and a network interface 216. These components of reader 104 may include software, hardware, and/or firmware, or any combination thereof, for performing their functions.

Baseband processor 212 and network interface 216 are optionally present in reader 104. Baseband processor 212 may be present in reader 104, or may be located remote from reader 104. For example, in an embodiment, network interface 216 may be present in reader 104, to communicate between transceiver portion 220 and a remote server that includes baseband processor 212. When baseband processor 212 is present in reader 104, network interface 216 may be optionally present to communicate between baseband processor 212 and a remote server. In another embodiment, network interface 216 is not present in reader 104.

In an embodiment, reader 104 includes network interface 216 to interface reader 104 with a communications network 218. As shown in FIG. 2, baseband processor 212 and network interface 216 communicate with each other via a communication link 222. Network interface 216 is used to provide an interrogation request 210 to transceiver portion 220 (optionally through baseband processor 212), which may be received from a remote server coupled to communications network 218. Baseband processor 212 optionally processes the data of interrogation request 210 prior to being sent to transceiver portion 220. Transceiver 220 transmits the interrogation request via antenna 202.

Reader 104 has at least one antenna 202 for communicating with tags 102 and/or other readers 104. Antenna(s) 202 may be any type of reader antenna known to persons skilled in the relevant art(s), including a vertical, dipole, loop, Yagi-Uda, slot, or patch antenna type. For description of an example antenna suitable for reader 104, refer to U.S. patent application Ser. No. 11/265,143, filed Nov. 3, 2005, entitled “Low Return Loss Rugged RFID Antenna,” now pending, which is incorporated by reference herein in its entirety.

Transceiver 220 receives a tag response via antenna 202. Transceiver 220 outputs a decoded data signal 214 generated from the tag response. Network interface 216 is used to transmit decoded data signal 214 received from transceiver portion 220 (optionally through baseband processor 212) to a remote server coupled to communications network 218. Baseband processor 212 optionally processes the data of decoded data signal 214 prior to being sent over communications network 218.

In embodiments, network interface 216 enables a wired and/or wireless connection with communications network 218. For example, network interface 216 may enable a wireless local area network (WLAN) link (including an IEEE 802.11 WLAN standard link), a BLUETOOTH link, and/or other types of wireless communication links. Communications network 218 may be a local area network (LAN), a wide area network (WAN) (e.g., the Internet), and/or a personal area network (PAN).

In embodiments, a variety of mechanisms may be used to initiate an interrogation request by reader 104. For example, an interrogation request may be initiated by a remote computer system/server that communicates with reader 104 over communications network 218. Alternatively, reader 104 may include a finger-trigger mechanism, a keyboard, a graphical user interface (GUI), and/or a voice activated mechanism with which a user of reader 104 may interact to initiate an interrogation by reader 104.

In the example of FIG. 2, transceiver portion 220 includes a RF front-end 204, a demodulator/decoder 206, and a modulator/encoder 208. These components of transceiver 220 may include software, hardware, and/or firmware, or any combination thereof, for performing their functions. Example description of these components is provided as follows.

Modulator/encoder 208 receives interrogation request 210, and is coupled to an input of RF front-end 204. Modulator/encoder 208 encodes interrogation request 210 into a signal format, modulates the encoded signal, and outputs the modulated encoded interrogation signal to RF front-end 204. For example, pulse-interval encoding (PIE) may be used in a Gen 2 embodiment. Furthermore, double sideband amplitude shift keying (DSB-ASK), single sideband amplitude shift keying (SSB-ASK), or phase-reversal amplitude shift keying (PR-ASK) modulation schemes may be used in a Gen 2 embodiment. Note that in an embodiment, baseband processor 212 may alternatively perform the encoding function of modulator/encoder 208.

RF front-end 204 may include one or more antenna matching elements, amplifiers, filters, an echo-cancellation unit, a down-converter, and/or an up-converter. RF front-end 204 receives a modulated encoded interrogation signal from modulator/encoder 208, up-converts (if necessary) the interrogation signal, and transmits the interrogation signal to antenna 202 to be radiated. Furthermore, RF front-end 204 receives a tag response signal through antenna 202 and down-converts (if necessary) the response signal to a frequency range amenable to further signal processing.

Demodulator/decoder 206 is coupled to an output of RF front-end 204, receiving a modulated tag response signal from RF front-end 204. In an EPC Gen 2 protocol environment, for example, the received modulated tag response signal may have been modulated according to amplitude shift keying (ASK) or phase shift keying (PSK) modulation techniques. Demodulator/decoder 206 demodulates the tag response signal. For example, the tag response signal may include backscattered data formatted according to FM0 or Miller encoding formats in an EPC Gen 2 embodiment. Demodulator/decoder 206 outputs decoded data signal 214. Note that in an embodiment, baseband processor 212 may alternatively perform the decoding function of demodulator/decoder 206.

The configuration of transceiver 220 shown in FIG. 2 is provided for purposes of illustration, and is not intended to be limiting. Transceiver 220 may be configured in numerous ways to modulate, transmit, receive, and demodulate RFID communication signals, as would be known to persons skilled in the relevant art(s).

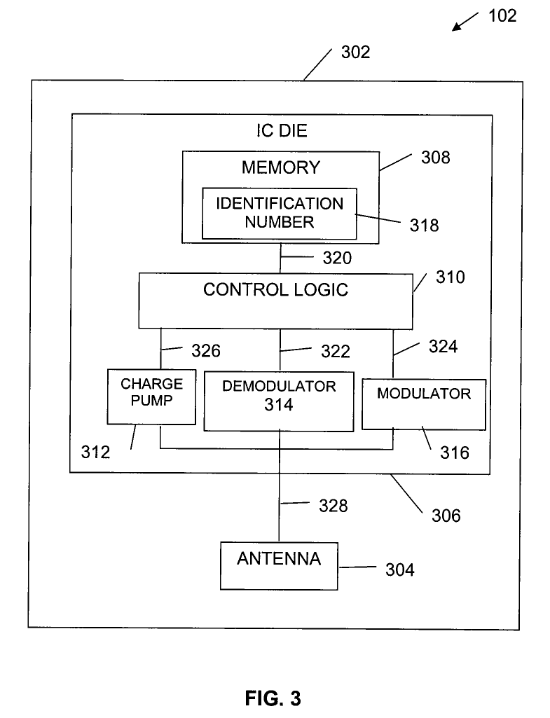

The present invention is applicable to any type of RFID tag. FIG. 3 shows a plan view of an example radio frequency identification (RFID) tag 102. Tag 102 includes a substrate 302, an antenna 304, and an integrated circuit (IC) 306. Antenna 304 is formed on a surface of substrate 302. Antenna 304 may include any number of one, two, or more separate antennas of any suitable antenna type, including dipole, loop, slot, or patch antenna type. IC 306 includes one or more integrated circuit chips/dies, and can include other electronic circuitry. IC 306 is attached to substrate 302, and is coupled to antenna 304. IC 306 may be attached to substrate 302 in a recessed and/or non-recessed location.

IC 306 controls operation of tag 102, and transmits signals to, and receives signals from RFID readers using antenna 304. In the example embodiment of FIG. 3, IC 306 includes a memory 308, a control logic 310, a charge pump 312, a demodulator 314, and a modulator 316. An input of charge pump 312, an input of demodulator 314, and an output of modulator 316 are coupled to antenna 304 by antenna signal 328. Note that in the present disclosure, the terms “lead” and “signal” may be used interchangeably to denote the connection between elements or the signal flowing on that connection.

Memory 308 is typically a non-volatile memory, but can alternatively be a volatile memory, such as a DRAM. Memory 308 stores data, including an identification number 318. Identification number 318 typically is a unique identifier (at least in a local environment) for tag 102. For instance, when tag 102 is interrogated by a reader (e.g., receives interrogation signal 110 shown in FIG. 1), tag 102 may respond with identification number 318 to identify itself. Identification number 318 may be used by a computer system to associate tag 102 with its particular associated object/item.

Demodulator 314 is coupled to antenna 304 by antenna signal 328. Demodulator 314 demodulates a radio frequency communication signal (e.g., interrogation signal 110) on antenna signal 328 received from a reader by antenna 304. Control logic 310 receives demodulated data of the radio frequency communication signal from demodulator 314 on input signal 322. Control logic 310 controls the operation of RFID tag 102, based on internal logic, the information received from demodulator 314, and the contents of memory 308. For example, control logic 310 accesses memory 308 via a bus 320 to determine whether tag 102 is to transmit a logical “1” or a logical “0” (of identification number 318) in response to a reader interrogation. Control logic 310 outputs data to be transmitted to a reader (e.g., response signal 112) onto an output signal 324. Control logic 310 may include software, firmware, and/or hardware, or any combination thereof. For example, control logic 310 may include digital circuitry, such as logic gates, and may be configured as a state machine in an embodiment.

Modulator 316 is coupled to antenna 304 by antenna signal 328, and receives output signal 324 from control logic 310. Modulator 316 modulates data of output signal 324 (e.g., one or more bits of identification number 318) onto a radio frequency signal (e.g., a carrier signal transmitted by reader 104) received via antenna 304. The modulated radio frequency signal is response signal 112, which is received by reader 104. In an embodiment, modulator 316 includes a switch, such as a single pole, single throw (SPST) switch. The switch changes the return loss of antenna 304. The return loss may be changed in any of a variety of ways. For example, the RF voltage at antenna 304 when the switch is in an “on” state may be set lower than the RF voltage at antenna 304 when the switch is in an “off” state by a predetermined percentage (e.g., 30 percent). This may be accomplished by any of a variety of methods known to persons skilled in the relevant art(s).

Charge pump 312 is coupled to antenna 304 by antenna signal 328. Charge pump 312 receives a radio frequency communication signal (e.g., a carrier signal transmitted by reader 104) from antenna 304, and generates a direct current (DC) voltage level that is output on a tag power signal 326. Tag power signal 326 is used to power circuits of IC die 306, including control logic 310.

In an embodiment, charge pump 312 rectifies the radio frequency communication signal of antenna signal 328 to create a voltage level. Furthermore, charge pump 312 increases the created voltage level to a level sufficient to power circuits of IC die 306. Charge pump 312 may also include a regulator to stabilize the voltage of tag power signal 326. Charge pump 312 may be configured in any suitable way known to persons skilled in the relevant art(s). For description of an example charge pump applicable to tag 102, refer to U.S. Pat. No. 6,734,797, entitled “Identification Tag Utilizing Charge Pumps for Voltage Supply Generation and Data Recovery,” which is incorporated by reference herein in its entirety. Alternative circuits for generating power in a tag are also applicable to embodiments of the present invention.

It will be recognized by persons skilled in the relevant art(s) that tag 102 may include any number of modulators, demodulators, charge pumps, and antennas. Tag 102 may additionally include further elements, including an impedance matching network and/or other circuitry. Embodiments of the present invention may be implemented in tag 102, and in other types of tags. Furthermore, although tag 102 is shown in FIG. 3 as a passive tag, tag 102 may alternatively be an active tag (e.g., powered by battery).

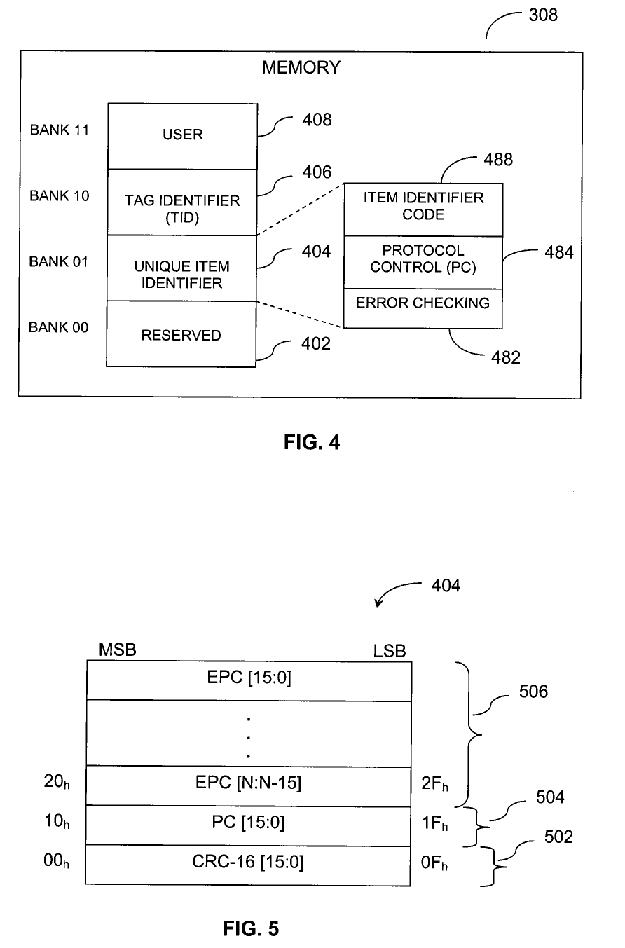

Memory 308 may have a variety of logical structures. FIG. 4 shows a logical representation of memory 308 in an example Gen 2-type RFID tag. As shown in FIG. 4, memory 308 is logically separated into first-fourth memory banks 402, 404, 406, and 408. Tag memory 308 includes a reserved bank 402 (bank 00), a unique item identifier bank 404 (bank 01), a tag identifier bank 406 (bank 10), and a user memory bank 408 (bank 11). Each bank may have any number of memory words. Additionally, the format of one or more memory banks may be established by an industry, governmental, standards, or other similar type of organization.

First memory bank 402 may be referred to as “reserved memory” or “memory bank 00.” Memory bank 402 is configured to store kill and access passwords for the tag. The access password is a 32-bit value stored in memory addresses 20hex to 3Fhex. A default (unprogrammed) value for the access password is zero. Tags with a nonzero access password require a reader to issue the access password before transitioning to a secured state. A tag that does not implement an access password operates as though it had a zero-valued access password that is permanently read/write locked.

Second memory bank 404 may be referred to as “Unique Item Identifier (UII)” or “memory bank 01.” Memory bank 404 is configured to store an error checking code 482 (e.g., a CRC-16), protocol control (PC) bits 484, and an item identifier code 486. In an embodiment, PC bits 484 include one or more application family identifier (AFI) bits (e.g., PC bit 17). Item identifier code 486 may identify the object to which the tag is attached.

In an example, second memory bank 404 may be referred to as “EPC memory.” FIG. 5 shows further detail of an EPC memory bank 404 in a Gen 2-type tag. In a first memory portion 502 at memory addresses 00hex to 0Fhex of memory bank 404, a 16-bit cyclic redundancy check (CRC) checksum (“CRC-16”) is stored. In a second memory portion 504 at memory addresses 10hex to 1Fhex of memory bank 404, Protocol-Control (PC) bits are stored. In a third memory portion 506 beginning at 20hex of memory bank 404, a code is stored (such as an electronic product code (EPC)) that identifies the object to which the tag is associated.

Third memory bank 406 may be referred to as “TID memory” or “memory bank 10.” Memory bank 406 stores identification information for a tag, such as an allocation class identifier for the tag and information regarding the unique commands and/or optional features supported by the tag. For example, memory bank 406 can store an 8-bit ISO/IEC 15963 allocation class identifier (111000102 for EPCglobal) at memory locations 00hex to 07hex. Memory bank 406 can further include sufficient identifying information above 07hex for a reader to uniquely identify the custom commands and/or optional features that the tag supports.

Fourth memory bank 408 may be referred to as “user memory” or “memory bank 11.” Memory bank 408 stores user-specific data. The organization of memory bank 408 is user-defined.

Further description of memory banks 402-408 in a Gen 2-type tag can be found in “EPC™ Radio-Frequency Identity Protocols, Class-1 Generation-2 UHF RFID, Protocol for Communications at 860 MHz-960 MHz,” Version 1.0.9, EPCglobal, Inc., copyright 2004, dated Jan. 1, 2005, pages 1-94 (see section 6.3.2.1, pages 35 and 36), which is incorporated by reference herein in its entirety.

Embodiments described herein are applicable to all forms of tags, including tag “inlays” and “labels.” A “tag inlay” or “inlay” is defined as an assembled RFID device that generally includes an integrated circuit chip (and/or other electronic circuit) and antenna formed on a substrate, and is configured to respond to interrogations. A “tag label” or “label” is generally defined as an inlay that has been attached to a pressure sensitive adhesive (PSA) construction, or has been laminated, and cut and stacked for application. A “tag” is generally defined as a tag inlay that has been attached to another surface, or between surfaces, such as paper, cardboard, etc., for attachment to an object to be tracked, such as an article of clothing, etc.

Example embodiments of the present invention are described in further detail below. Such embodiments may be implemented in the environments, readers, and tags described above, and/or in alternative environments and alternative RFID devices. For example, embodiments of the present invention may be implemented with regard to pharmaceutical, defense, border control (e.g., passports), and other applications.

Example Embodiments for Changing Memory Pointers

The example embodiments described herein are provided for illustrative purposes, and are not limiting. The examples described herein may be adapted to any type of tag and reader. Further structural and operational embodiments, including modifications/alterations, will become apparent to persons skilled in the relevant art(s) from the teachings herein.

Methods, systems, and apparatuses for improved management of data stored in tags are described. Embodiments of the present invention may be implemented in a wide variety of types of tags, including EPC Class 0, Class 1, and Gen 2 type tags.

As described above, memory pointer values are often used to indicate boundaries or start locations of contents within a memory instance. These pointer values are typically indicated with count values that are modified using normal mathematical constructs, such as addition and subtraction. In cases where writing (or updating) a new pointer value is susceptible to faulty write conditions (e.g., low power or other questionable write procedures that may terminate before verification of a successful write is completed), it may be possible for the updated pointer value to become corrupt. For example, the pointer may be corrupted because multiple bits of the pointer value may need to be changed in the value update, and due to an interruption, all of the bits of the pointer value may not be updated properly. An example interruption may occur when a tag runs out of power. A passive tag may receive and store energy from a RF carrier signal transmitted by a reader for use by tags for power. When a tag moves out of range of the reader, the tag may run out of the stored energy, and thus may power down in a form of “brownout.” If the tag powers down while changing a memory pointer, the memory pointer may become corrupted.

Such a condition of a corrupted pointer value can be catastrophic for some systems, such as a RFID tag, where a pointer value may be used to protect read or write locked memory boundaries in memory of the tag, for example. Corrupting this type of pointer value may uncover or expose the previously protected memory regions. It is desired to protect information embedded in tags from being obtained by unauthorized readers.

Embodiments of the present invention utilize pointer values updated according to Gray code. In accordance with Gray code, when a pointer is incremented or decremented, the pointer value changes by a single bit. Thus, pointer updates that occur under faulty conditions will either take on the newly incremented (desired) value (i.e., a single bit changed), or retain the previously stored value (i.e., the single bit was not changed), until the system can perform verification of the successfully completed write operation. If the write did not complete successfully, the pointer update can be performed again without corrupting the previous pointer value and/or uncovering critical protected memory contents.

Table 1 shown below shows an example of counting according to a natural binary code compared with counting according to Gray code, for a 3-bit value:

TABLE 1

| Decimal | Binary Code | Gray Code |
|---|---|---|
| 0 | 000 | 000 |
| 1 | 001 | 001 |
| 2 | 010 | 011 |
| 3 | 011 | 010 |
| 4 | 100 | 110 |
| 5 | 101 | 111 |
| 6 | 110 | 101 |
| 7 | 111 | 100 |

As shown in Table 1, incrementing or decrementing by one changes a single bit value in a Gray coded binary number. For example, in Gray code, incrementing from 5 (“111”) to 6 (“101”) changes only the middle bit, which changes from 1 to 0. In natural binary code, incrementing from 5 (“101”) to 6 (“110”) changes both the least significant and middle bits. In Gray code, decrementing from 4 (“110”) to 3 (“010”) changes only the most significant bit, which changes from 1 to 0. In natural binary code, decrementing from 4 (“100”) to 3 (“011”) changes all three bits.

The Gray code shown in Table 1 is binary-reflected Gray code. Binary-reflected Gray code supports a one-bit rollover from a maximum value (e.g., 7 (“100”)) to a minimum value e.g., 0 (“000”)). It also supports hardware translations to and from natural binary code.

Thus according to embodiments, utilizing Gray code, a pointer value in tag memory can be incremented or decremented by 1, only changing one bit value during a successful operation. If a pointer is not incremented or decremented successfully, then the pointer value does not change at all. Thus, in contrast, utilizing natural binary code, a pointer value that does not increment or decrement successfully could change to an undesired value. For example, in natural binary code, unsuccessfully decrementing from 4 (“100”) to 3 (“011”) may result in none, one, or two of any of the bit positions changing value, such as erroneously changing from 4 (“100”) to 7 (“111”, where the most significant bit fails to change 1 to 0), 4 (“100”) to 5 (“101”, where the most significant bit and middle bit both fail to change), etc. Thus, when unsuccessfully attempting to decrement a pointer value according to natural binary code, the pointer value may actually be incremented, exposing a location of memory that was not intended to be exposed.

In an example embodiment, tags can have one or more memory lock boundary pointers using Gray coded count values, so that critical pointer updates can be safely performed in the presence of power brownout conditions. Gray coded pointers are used for addressing memory in RFID tags to prevent pointer corruption from power loss.

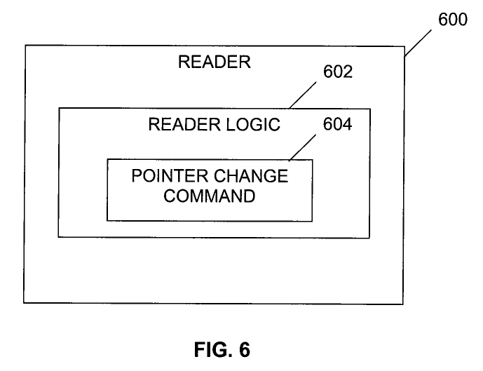

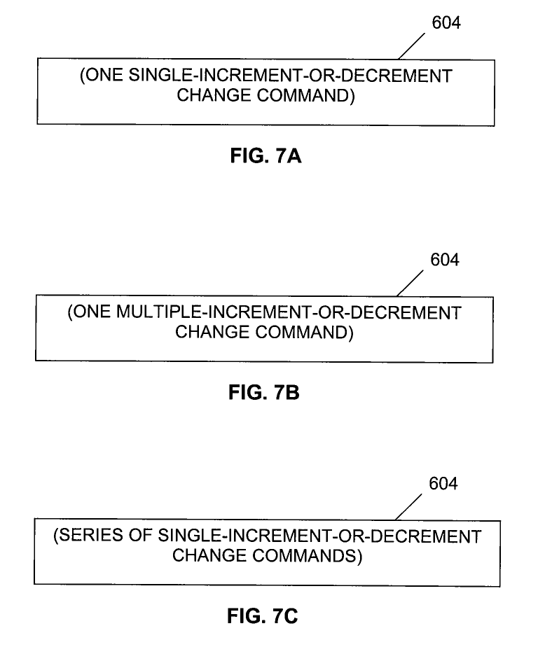

For example, FIG. 6 shows an example reader 600, according to an embodiment of the present invention. Reader 600 may be configured similarly to reader 104 described above, or in an alternative reader configuration. As shown in FIG. 6, reader 600 includes reader logic 602. Reader logic 602 is configured to update a pointer in memory in a tag. For example, a tag may have a particular amount of memory designated for users out of a total amount of memory. It may be desired to alter that amount of user memory, such as to increase the amount of memory designated for users. A boundary at a particular address in memory indicated by a memory pointer in the tag may be the location where user memory begins. It may be desired to expand the user memory, and thus to change the value of the memory pointer indicating where user memory begins. As shown in FIG. 6, reader logic 602 generates a pointer change command 604. Pointer change command 604 may include an indication whether to increment or decrement the memory pointer in the tag by one memory location. For example, the pointer change command can consist of one single-increment-or-decrement change command, as shown in FIG. 7A. Alternatively, pointer change command 604 may include a parameter indicating a number of one or more memory locations by which the tag memory pointer should be changed (incremented or decremented). In other words, the pointer change command can consist of a multiple-increment-or-decrement change command, as shown in FIG. 7B. As a further alternative, the pointer change command can consist of a series of single-increment-or-decrement change commands, as shown in FIG. 7C. In an embodiment, the pointer change command can be in the form of an instruction. In another embodiment, the pointer change command can consist of one or more pin configurations. Furthermore, in an embodiment, pointer change command 604 may include a password. Reader 600 transmits pointer change command 604 to a tag to cause the memory pointer change.

Reader logic 602 may include hardware, software, firmware, or any combination thereof to perform its functions. Reader logic 602 may be configured to be triggered to perform this function by an operator of reader 600, by a computer system coupled to reader 600, and/or in other manners, including any of the ways described elsewhere herein.

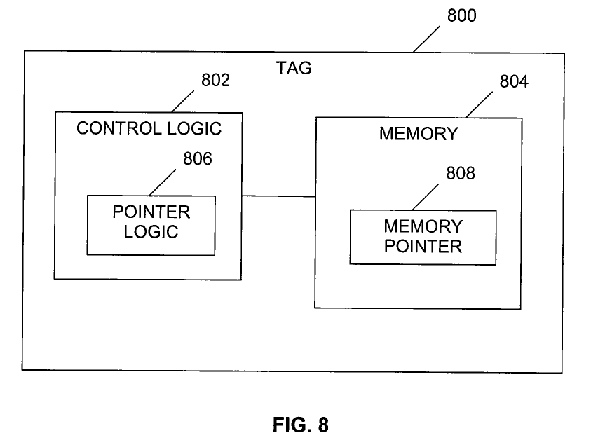

FIG. 8 shows a tag 800, according to an example embodiment of the present invention. Tag 800 may be configured similarly to tag 102 described above or in an alternative tag configuration, and may be configured to communicate according to Class 0, Class 1, Gen 2, and/or other present and/or future RFID communication protocols. Tag 800 is configured to change a value of a memory pointer when instructed to do so by a reader. For example, in an embodiment, tag 800 increments or decrements the memory pointer by a value of one or more memory locations, as indicated by pointer change command 604 after receiving pointer change command 604 from reader 600. Tag 800 increments or decrements the memory pointer according to Gray code, so that only a single bit changes value in the memory pointer during an increment or decrement by 1. In an embodiment, when a password is required, tag 800 verifies the password (e.g., compares the received password to a stored password) received with pointer change command 604 before executing pointer change command 604.

For example, in an EPC Gen 2 embodiment, pointer change command 604 may be a CUSTOM command. Refer to “EPC™ Radio-Frequency Identity Protocols, Class-1 Generation-2 UHF RFID, Protocol for Communications at 860 MHz-960 MHz,” Version 1.0.9, EPCglobal, Inc., copyright 2004, dated Jan. 1, 2005, pages 1-94 (hereinafter “Gen 2 Specification”) for information on CUSTOM commands for a Gen 2 embodiment for tag 800.

As shown in FIG. 8, tag 800 includes control logic 802, which may be incorporated in control logic 310 described above with respect to FIG. 3, for example. Control logic 802 includes pointer logic 806. Pointer logic 806 is configured to change a pointer value stored in memory pointer 808 in a memory 804 of tag 800 when instructed by a reader, such as reader 600. Pointer logic 806 is configured to change the pointer value stored in memory pointer 808 according to Gray code, as described above. In an embodiment, pointer logic 806 processes a pointer change command 604 received from reader 600 (and optionally a password). Pointer logic 806 may include hardware, software, firmware, or any combination thereof to perform its functions.

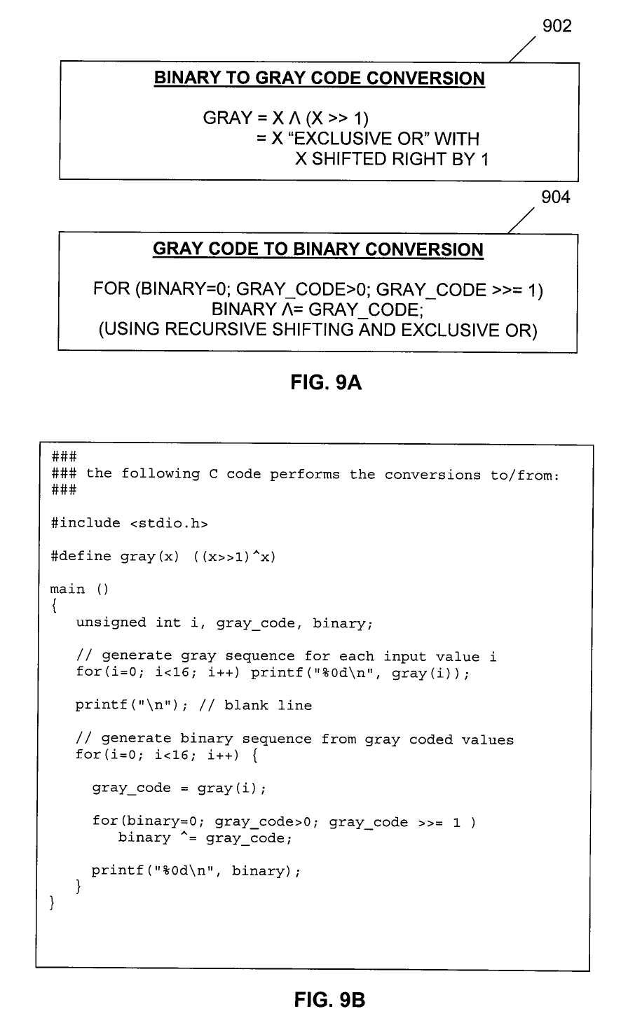

In an embodiment, tag 800 is configured to convert natural binary code to Gray code, and vice versa. For example, a memory pointer address can be converted from natural binary code to Gray code prior to incrementing or decrementing, and/or storing. Likewise, a Gray coded address can be converted from Gray code to natural binary before decoding or address comparison. The conversion to and from Gray code can occur in hardware, software, and/or firmware of control logic 802 or pointer logic 806, for example. Examples of conversion logic for converting to and from Gray code are shown in FIGS. 9A and 9B.

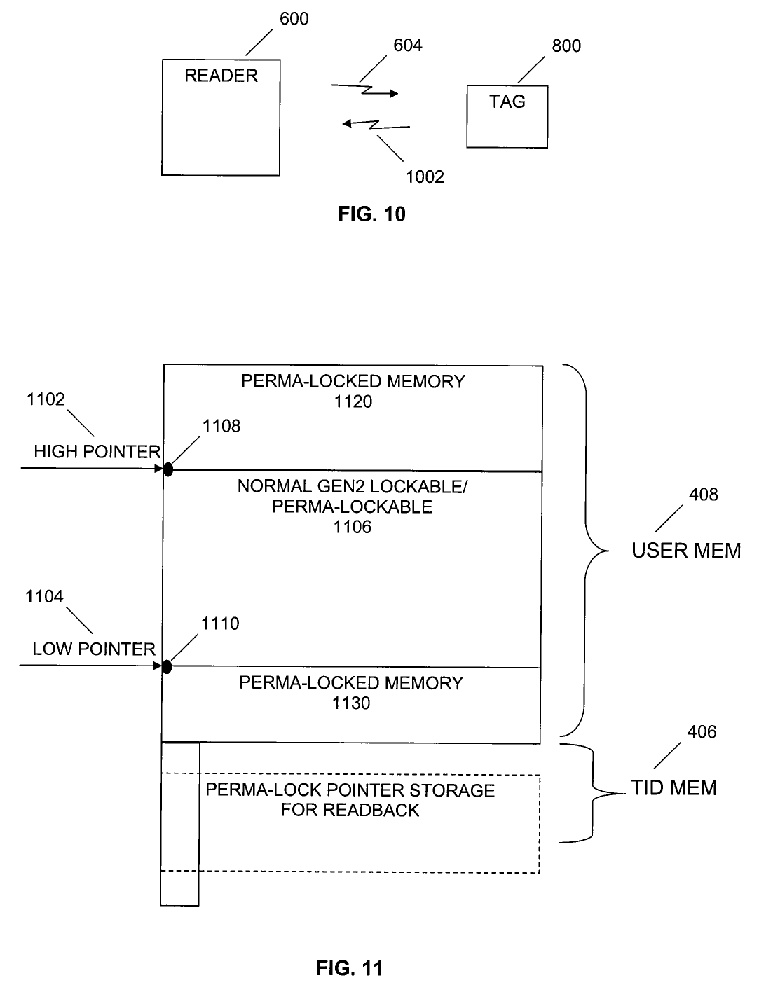

FIG. 10 shows example communications between reader 600 and tag 800, where reader 600 transmits a pointer change command 604 to tag 800, and tag 800 transmits a response signal 1002 to reader 600. In an embodiment, tag 800 does not acknowledge to reader 600 that tag 800 successfully changed a pointer value, or that tag 800 did not change the pointer value, such as if power was lost or if pointer logic 806 determined that a received passcode did not match a stored passcode. In another embodiment, tag 800 transmits a response signal 1002 to reader 600. If tag 800 successfully changed its pointer value, response signal 1002 may include an indication of this. If tag 800 did not successfully change its pointer value, response signal 1002 may include an indication of this.

FIG. 11 shows an example embodiment where first and second memory pointers 1102 and 1104 are used to indicate the boundaries of a memory portion 1106 in memory 804 of tag 800. Although FIG. 11 shows a Gen 2 embodiment, the invention is not to be limited to Gen 2. In this example embodiment, first memory pointer 1102 stores a first, higher memory location 1108, and second memory pointer 1104 stores a second, lower memory location 1110. In an embodiment, pointer change command 604 can change either or both of first and second memory pointers 1102 and 1104, to respectively change higher memory location 1108 and lower memory location 1110, and thereby contract or expand memory portion 1106 in either or both directions (up and/or down in memory 804).

For example, in a Gen 2 embodiment as shown in FIG. 11, a first memory portion 1120 above memory portion 1106 in memory 804 may be a locked memory portion, not accessible to users. A second memory portion 1130 below memory portion 1106 in memory 804 may be a locked memory portion, not accessible to users. For example, pointers, such as memory pointers 1102 and 1104 may be stored in second memory portion 1130 (or in first memory portion 1120). Thus, for instance, second memory portion 1130 may be third memory bank 406, “TID memory”, while memory portion 1106 may be fourth memory bank 408, “User memory.” Memory portion 1106 may be accessible by users (e.g., for read and/or write access), and/or may be locked or not locked by users. In embodiments, any types of memory and/or combinations of locked, unlocked, and lockable memory may be present, depending on a particular application.

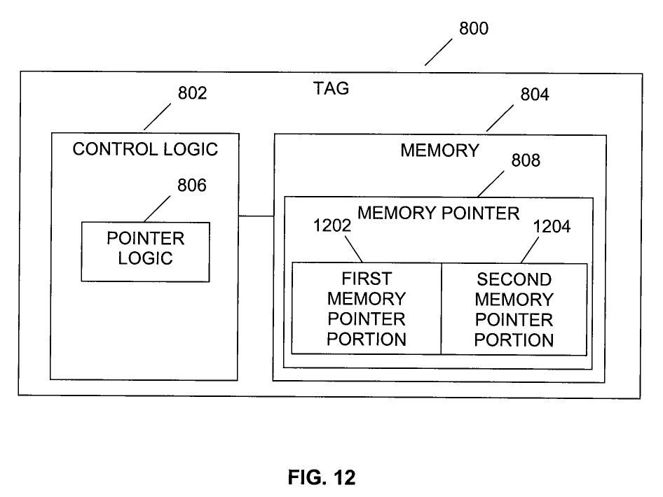

In an embodiment, pointer change command 604 increments or decrements one or more memory pointers of a tag by 1. For example, memory pointer 808 may be divided into two or more pointer portions that are each separately changeable according to Gray code. FIG. 12 shows tag 800 of FIG. 8 with memory pointer 808 having a first memory pointer portion 1202 and a second memory pointer portion 1204. After receiving pointer change command 604 to change a memory pointer 808, pointer logic 806 calculates the change into separate changes required for each of first and second memory pointer portions 1202 and 1204. Pointer logic 806 separately updates first memory pointer portion 1202 and second memory pointer portion 1204. For example, first and second memory pointer portions 1202 and 1204 may be separate 8-bit pointer registers that form a 16 bit memory pointer 808. In an embodiment, additional tag logic is used to combine first and second memory pointer portions 1202 and 1204 into a final address. However, this final address need not necessarily be stored. Instead, this 16-bit address may be calculated as needed.

Memory Pointer Change Methods

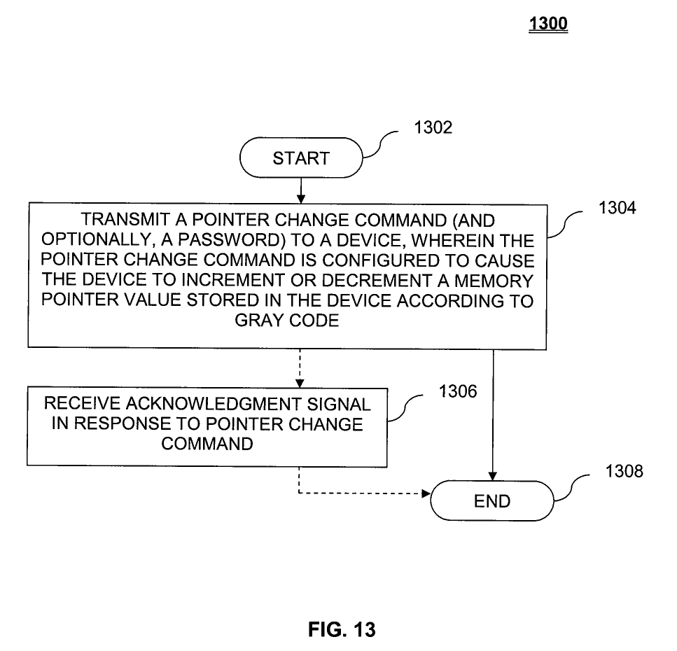

Various methods for changing memory pointers will now be described, according to example embodiments of the present invention. These methods are depicted in the flowcharts of FIGS. 13-20.

FIG. 13 is a flowchart depicting a method 1300 for changing a memory pointer (such as memory pointer 808 of RFID tag 800), according to an example embodiment of the present invention. Method 1300 begins at step 1302. In step 1304, a pointer change command (e.g., pointer change command 604) is transmitted to a device (e.g., RFID tag 800). The transmitted pointer change command is configured to cause the device to increment or decrement a memory pointer value (e.g., memory pointer 808) stored in the device according to Gray code. Optionally, a password associated with the pointer change command is also transmitted. In optional step 1306, an acknowledgement signal from the device is received (in response signal 1002, for example). Method 1300 ends at step 1308.

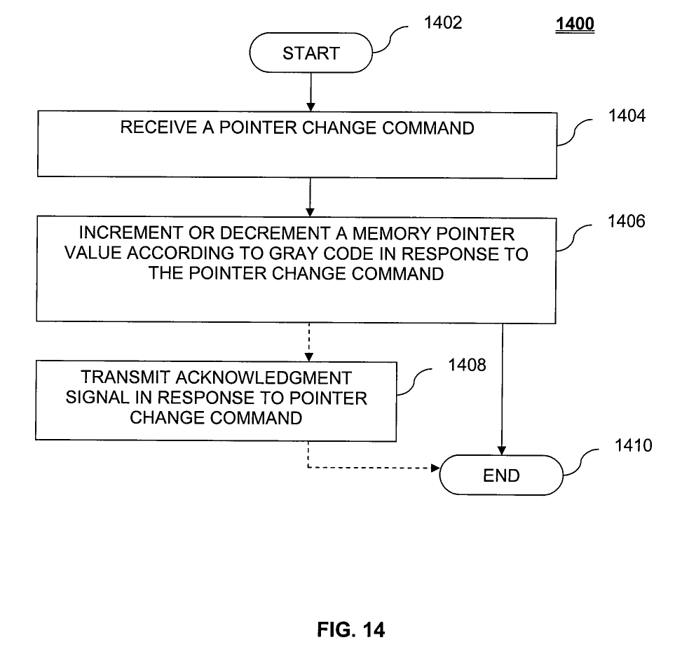

FIG. 14 is a flowchart depicting a method 1400 for changing a memory pointer in a device (e.g., RFID tag 800), according to an example embodiment of the present invention. Method 1400 begins at step 1402. In step 1404, a pointer change command (e.g., pointer change command 604) is received (e.g., from RFID reader 600). In step 1406, a memory pointer value (e.g., memory pointer 808) stored in the device is incremented or decremented according to Gray code in response to the pointer change command. In optional step 1408, an acknowledgment signal is transmitted (e.g., from the RFID tag 800 to the RFID reader 600). Method 1400 ends at step 1410.

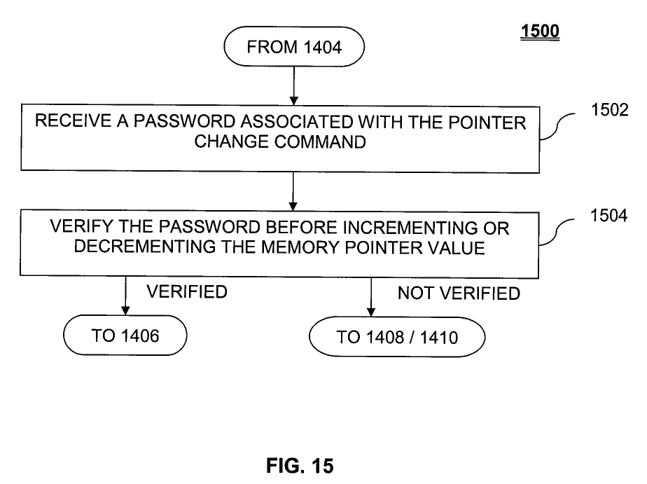

FIG. 15 is a flowchart 1500 depicting an example of additional steps that can be included in the method shown in FIG. 14, according to an embodiment of the present invention. From step 1404 of method 1400, the method can proceed to step 1502. In step 1502, a password associated with the pointer change command is received (e.g., from the RFID reader 600). In step 1504, the password is verified. If the password is acceptable, method 1400 then proceeds to step 1406 in which the memory pointer value is incremented or decremented. If the password is not acceptable, method 1400 then proceeds with step(s) 1408/1410.

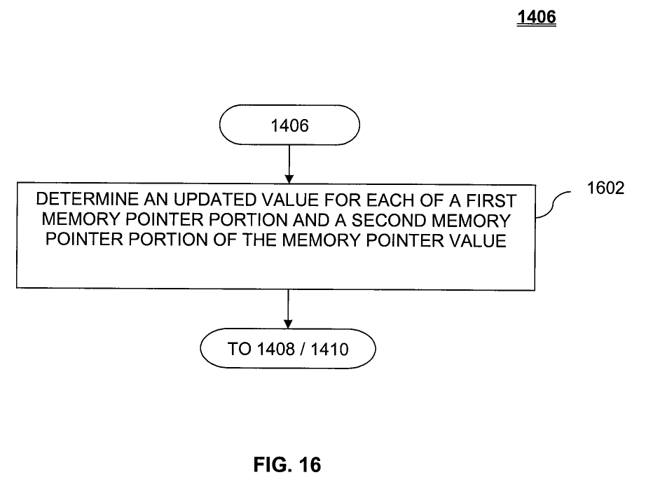

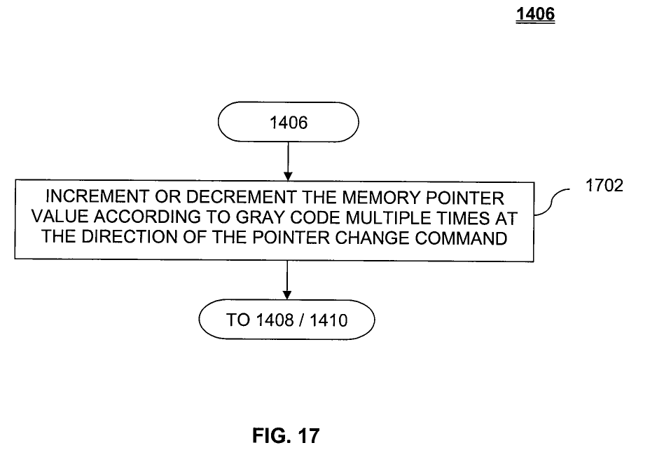

FIGS. 16 and 17 are each a flowchart further describing step 1406 of the method depicted in FIG. 14, according to example embodiments of the present invention. In FIG. 16, step 1406 includes determining an updated value for each of a first memory pointer portion (e.g., first memory pointer portion 1202) and a second memory pointer portion (e.g., second memory pointer portion 1204) of the memory pointer value (step 1602). Method 1400 then proceeds with step(s) 1408/1410.

In FIG. 17, step 1406 includes incrementing or decrementing the memory pointer value according to Gray code multiple times at the direction of the pointer change command (step 1702). For example, pointer change command 604 can include a parameter indicating a number of more than one memory locations by which the tag memory pointer should be changed (incremented or decremented). In other words, the pointer change command can consist of a multiple-increment-or-decrement change command, as shown in FIG. 7B. Alternatively, the pointer change command can consist of a series of single-increment-or-decrement change commands, as shown in FIG. 7C. Method 1400 then proceeds with step(s) 1408/1410.

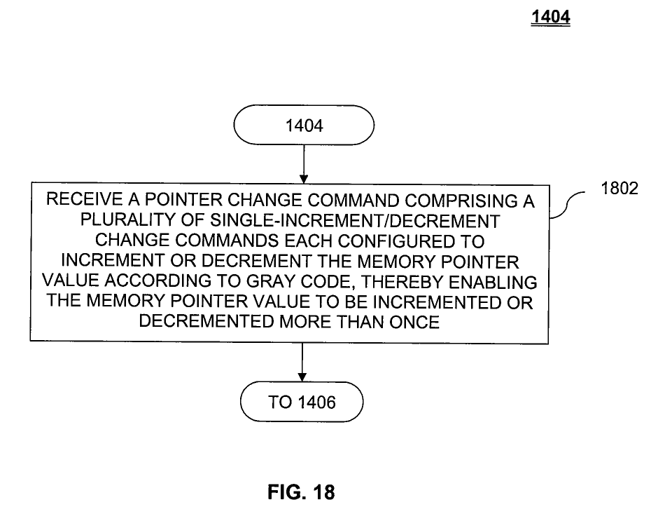

As an example of step 1702 (and FIG. 7C), FIG. 18 is a flowchart further describing step 1404 of the method depicted in FIG. 14, according to an example embodiment of the present invention. In FIG. 18, step 1404 includes receiving a pointer change command (e.g., pointer change command 604) comprising a plurality of single-increment-or-decrement change commands, each configured to increment or decrement the memory pointer value according to Gray code. This enables the memory pointer value to be incremented or decremented more than once. Method 1400 then proceeds to step 1406 to execute the incrementing or decrementing.

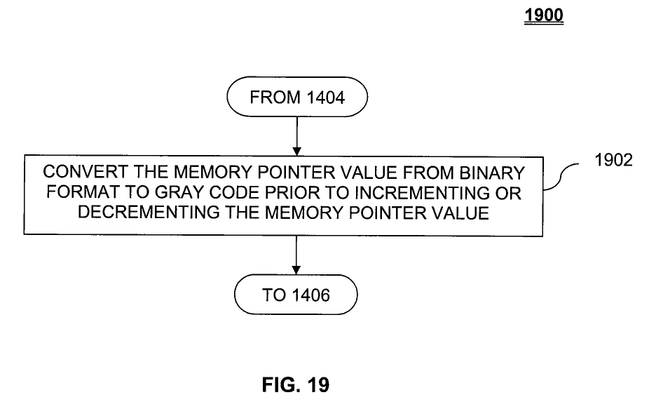

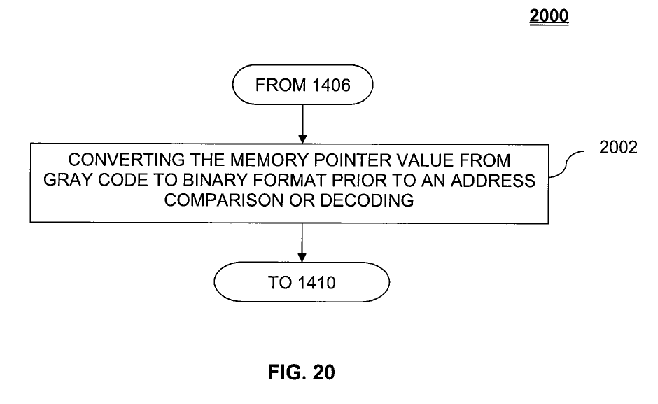

FIGS. 19 and 20 are each a flowchart depicting an example of an additional step that can be included in the method shown in FIG. 14, according to example embodiments of the present invention. From step 1404 of FIG. 14, method 1400 proceeds to step 1902 of flowchart 1900 of FIG. 19. In step 1902, the memory pointer value is converted from binary format (e.g., natural binary format) to Gray code prior to it being incremented or decremented. Method 1400 then proceeds to step 1406.

In FIG. 20, method 1400 proceeds to step 2002 of flowchart 2000 from step 1406. In step 2002, the memory pointer value is converted from Gray code to binary format (e.g., natural binary format) prior to it being used in an address comparison or prior to it being decoded. Method 1400 then proceeds to step 1410.

Example Computer System Embodiments

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system. The invention, in an embodiment, is directed to such computer program products.

In an embodiment where aspects of the present invention are implemented using software, the software may be stored in a computer program product and loaded into a computer system using a removable storage drive, hard drive, or communications interface. The control logic (software), when executed by a processor, causes the processor to perform the functions of the invention as described herein.

According to an example embodiment, a reader may execute computer-readable instructions to communicate with a tag to change one or more memory pointers of the tag, as described above.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1-9. (canceled)

10. A device, comprising:
a pointer logic; and
a memory that stores a memory pointer,
wherein the pointer logic is configured to increment or decrement the memory pointer according to Gray code.

11. The device of claim 10, wherein the device is configured to receive a pointer change command to cause the pointer logic to increment or decrement the memory pointer according to Gray code.

12. The device of claim 11, wherein the device is configured to receive the pointer change command from a radio frequency identification (RFID) reader.

13. The device of claim 11, wherein the device is configured to send an acknowledgment signal in response to the pointer change command.

14. The device of claim 11, wherein the device is configured to verify a password received with the pointer change command before enabling the pointer logic to increment or decrement the memory pointer according to Gray code.

15. The device of claim 11, wherein the pointer change command is configured to increment or decrement the memory pointer according to Gray code multiple times, thereby enabling the memory pointer to be incremented or decremented more than once.

16. The device of claim 11, wherein the pointer change command includes a plurality of single-increment-or-decrement change commands each configured to increment or decrement the memory pointer according to Gray code, thereby enabling the memory pointer to be incremented or decremented more than once.

17. The device of claim 10, wherein the memory pointer includes a first memory pointer portion and a second memory pointer portion.

18. The device of claim 17, wherein the pointer logic is configured to determine an updated value for each of the first memory pointer portion and the second memory pointer portion during an increment or decrement of the memory pointer.

19. The device of claim 10, wherein the pointer logic is configured to convert the memory pointer from binary format to Gray code prior to incrementing or decrementing the memory pointer.

20. The device of claim 19, wherein the pointer logic is configured to convert the memory pointer from Gray code to binary format prior to an address comparison or decoding.

21. The device of claim 10, wherein the pointer logic is configured to increment or decrement the memory pointer according to binary-reflected Gray code.

22. The device of claim 10, wherein the device is a radio frequency identification (RFID) tag.

23-34. (canceled)

35. A method for changing a memory pointer in a device, comprising:
receiving a pointer change command; and
incrementing or decrementing a memory pointer value stored in the device according to Gray code in response to the pointer change command.

36. The method of claim 35, wherein the receiving comprises:
receiving the pointer change command from a radio frequency identification (RFID) reader.

37. The method of claim 35, further comprising:
transmitting an acknowledgment signal in response to the pointer change command.

38. The method of claim 35, further comprising:
receiving a password associated with the pointer change command; and
verifying the password before incrementing or decrementing the memory pointer value.

39. The method of claim 35, wherein the incrementing or decrementing comprises:
determining an updated value for each of a first memory pointer portion and a second memory pointer portion of the memory pointer value.

40. The method of claim 35, wherein the incrementing or decrementing comprises:
incrementing or decrementing the memory pointer value according to Gray code multiple times at the direction of the pointer change command.

41. The method of claim 35, wherein the receiving a pointer change command comprises:
receiving a pointer change command comprising a plurality of single-increment-or-decrement change commands each configured to increment or decrement the memory pointer value according to Gray code, thereby enabling the memory pointer value to be incremented or decremented more than once.

42. The method of claim 35, further comprising:
converting the memory pointer value from binary format to Gray code prior to incrementing or decrementing the memory pointer value; and
converting the memory pointer value from Gray code to binary format prior to an address comparison or decoding.

43. The method of claim 35, wherein the incrementing or decrementing comprises:
incrementing or decrementing the memory pointer value according to binary-reflected Gray code.

44-46. (canceled)

47. A device, comprising:
means for receiving a pointer change command; and
means for incrementing or decrementing a memory pointer value stored in the device according to Gray code in response to the pointer change command.

48-49. (canceled)

50. The device of claim 47, further comprising:
means for determining an updated value for each of a first memory pointer portion and a second memory pointer portion of the memory pointer value.

51. The device of claim 47, further comprising:
means for converting the memory pointer value from binary format to Gray code prior to incrementing or decrementing the memory pointer value; and
means for converting the memory pointer value from Gray code to binary format prior to an address comparison or decoding.

52. (canceled)
